(19) United States
(12) Patent Application Publication
(10) Pub. No.: US 2010/0313528 A1
(43) Pub. Date: Dec. 16, 2010

(54) Envelope processing

(76) Inventors: Martin O'Malley, County Dublin (IE); Deirdre O'Malley, County Dublin (IE); Stephen Casey, Dublin 16 (IE); James Frost, Dublin 4 (IE); Ernie Herterich, Dublin 16 (IE); Michael O'Toole, Dublin 16 (IE)

Correspondence Address: JACOBSON HOLMAN PLLC, 400 SEVENTH STREET N.W., SUITE 600, WASHINGTON, DC, 20004, US

(21) Appl. No.: 12/801,499

(22) Filed: Jun. 11, 2010

Related U.S. Application Data
(60) Provisional application No. 61/213,485, filed on Jun. 12, 2009.

(51) Int. Cl. B65B 43/26; F16H 57/08; B65B 43/00

(52) U.S. Cl. 53/492; 475/331; 53/381.3

(57) ABSTRACT

A system for processing an envelope containing contents has stations for opening envelopes, and a checking station for checking contents of envelopes. The opening station comprises a cutter and a drive mechanism to separately cut opposed leaves of the envelope. The cutter comprises a wheel for cutting through each of the leaves, and the drive mechanism rotates the wheel and causes it to traverse across the envelope. There is a separate wheel for each envelope leaf and the drive mechanism simultaneously drives the wheels to cut both leaves simultaneously. The cutter comprises a separator for drawing the leaves away from each other so that they are separated from the contents during cutting. The separator comprises at least one suction cup for engaging the leaf and drawing it away from the plane of the contents; and there are opposed suction cups. The separator simultaneously draws the leaves in opposing directions away from the contents.

This application relates to processing of envelopes or like packages in high volumes such as at a facility that handles rented digital media discs returned by subscribers.

### BACKGROUND

Automation of processing of such packages presents considerable challenges because of the variations in size of contents and in their locations within the envelope. The challenge is to open the envelope in a manner whereby the contents are not damaged and can be efficiently removed for further processing.

Taking the example of processing of envelopes containing returned rental media discs such as DVDs, even though standard envelopes can be supplied to subscribers, there will be a variety of different manners in which subscribers will enclose the contents for return of the discs. For example, it is likely that a proportion of subscribers will insert a disc in the envelope with the wrong orientation. If a sleeve is supplied for a disc it may not be used to hold the disc, and may be inserted into the envelope alongside the disc. The envelope itself, although standard across all subscribers, may be sealed with varying degrees of overlap of the flap, thus presenting different dimensions for the sealed envelope. The latter variations present particular problems for automated equipment which relies on detection of the leading edge of the envelope to provide a reference datum for opening equipment.

U.S. Pat. No. 4,272,943 (Russell) describes an apparatus for processing envelopes. A pair of rotating cutters co-operate to sever an edge off an envelope. A problem with this approach is that the envelope may be sealed in a manner so that its edge is not where it is expected to be and so there can be an undesired variability in location of the severed edge. Also, if the contents fill the entire envelope or are located at this edge then they may be damaged.

WO94/00356 (Bongart) describes an approach in which a gripping member and a hook are used to open an envelope.

The invention is directed towards providing an apparatus and method for processing envelopes, in which there is improved automation efficiency, uniformity of envelope opening, and reduced risk of damage to envelope contents.

### SUMMARY OF THE INVENTION

According to the invention, there is provided a system for processing an envelope containing contents, the system comprising:
opposed cutters adapted to cut through envelope leaves,
a drive mechanism for the cutters,
characterized in that,
the system comprises a separator for drawing envelope leaves away from each other, and
the drive mechanism is adapted to drive the cutters to separately cut the opposed leaves of the envelope while they are drawn away from each other by the separator.

In one embodiment, the cutters include at least one wheel for cutting through an envelope leaf, and the drive mechanism is adapted to rotate the wheel and to cause it to traverse across the envelope. Preferably, the drive mechanism is adapted to simultaneously drive the wheels to cut both envelope leaves simultaneously.

In one embodiment, the separator comprises opposed suction cups adapted to engage envelope leaves and to draw them away from a plane of the envelope contents.

In one embodiment, the drive mechanism comprises a rail and a gear on the wheel engaging the rail in a rack-and-pinion type of action as the wheel traverses an envelope, translational motion of a wheel assembly along the rail causing rotation of the wheel. Preferably, the gear comprises a high-friction rubber or plastics material for engaging the rail by friction. Preferably, the rail is biased towards the gear.

In one embodiment, the separator and the cutters are driven by a single drive shaft having a cam for driving the cutters and a cam for driving the separator. In one embodiment, the separator and the cutters are driven by pneumatic rams.

In one embodiment, the system further comprises a tearing station for completing separation of parts of the envelope by tearing remaining envelope material which joins them after cutting.

In one embodiment, the tearing station comprises a clamp for gripping each envelope part and a drive for mutual separation of the clamps to tear said material.

In one embodiment, the clamp drive is adapted to rotate a clamp away from the plane of the envelope, and the clamp is adapted to release the envelope part held by the rotated clamp.

In one embodiment, the system further comprises an inspection station for inspecting the contents by checking for insertion of an item in a sleeve contained in the envelope.

In one embodiment, the inspection station comprises a suction cup arranged to attempt to grip the sleeve, failure of gripping indicating that the cup is in contact with the item instead of the sleeve, and said inspection station is adapted to grip the item to prevent movement of the item with movement of a cup, hence breaking suction if the cup is engaged with the item instead of the sleeve.

In one embodiment, the system further comprises a media disc cleaning station comprising at least one cleaning head and a planetary gear drive for the head.

In one embodiment, the planetary gear drive comprises an inner gear and an outer annular gear defining a path between them, the path having teeth engaging g a cleaning head drive shaft, whereby mutual rotation of at least the outer and inner gear causes rotation of the cleaning head in a circular orbit and to rotate about its own axis.

In one embodiment, the system comprises stations located around at least one carousel indexing table having a plurality of beds, an envelope intake for placing an envelope on an empty bed upon each indexing rotation of the table, a controller adapted to synchronise timing of operation of the stations, and wherein at least one of said stations includes said separator, said cutters, and said cutter drive mechanism and another of said stations.

In one embodiment, the system comprises a first carousel for processing envelopes and a second carousel for processing contents removed from the envelopes. Preferably, the second carousel includes a media cleaning station. Preferably, the second carousel comprises stations for correcting orientation of contents and mutual orientation of parts of contents such as a media disc in a sleeve.

In one embodiment, the method being implemented by a system comprising opposed cutters adapted to cut through envelope leaves, a drive mechanism for the cutters, a separator, and a drive mechanism, the method comprising the steps of:
the separator applying suction to opposed leaves of the envelope to cause them to separate, and
the cutters separately cutting through the opposed leaves while they are separated and the contents are between the cutters.

In one embodiment, the cutters are wheels which are simultaneously rotated and driven across the envelope in a translational motion to cut the leaves, and the method comprises the further step of tearing uncut parts of the envelope beyond the ends of a cut line by gripping opposed ends of the envelope and pulling them apart.

In another aspect, the invention provides a media disc cleaning system comprising at least one cleaning head and a planetary gear drive for the head, wherein the planetary gear drive comprises an inner gear and an outer annular gear defining a path between them, the path having teeth engaging g a cleaning head drive shaft, whereby mutual rotation of at least the outer and inner gear causes rotation of the cleaning head in a circular orbit and to rotate about its own axis.

### BRIEF DESCRIPTION OF DRAWINGS

The invention will be more clearly understood from the following description of some embodiments thereof given by way of example only with reference to the accompanying drawings, in which

FIG. 1 is a plan view of an envelope which is processed by a system of the invention;

FIG. 2 is a perspective view of a station for cutting opposed leaves of an envelope;

FIGS. 3(a) and 3(b) are diagrammatic front views showing operation of the station of FIG. 2, and

FIG. 4 is a plan view of the envelope after cutting;

FIG. 5(a) is a perspective view of a tearing station for completion of separation of the envelope into two parts, FIGS. 5(b) and 5(c) are diagrammatic perspective views showing operation of the tearing station, and

FIG. 6 shows the separated envelope which is outputted by the tearing station;

FIGS. 7 and 8 are diagrammatic side views showing processing of a sleeve and disc which are removed from the separated envelope;

FIG. 9 is a plan view of a station for cleaning the removed disc; and

FIGS. 10 and 11 are plan and perspective views of a first carousel of the overall envelope processing system.

### DETAILED DESCRIPTION

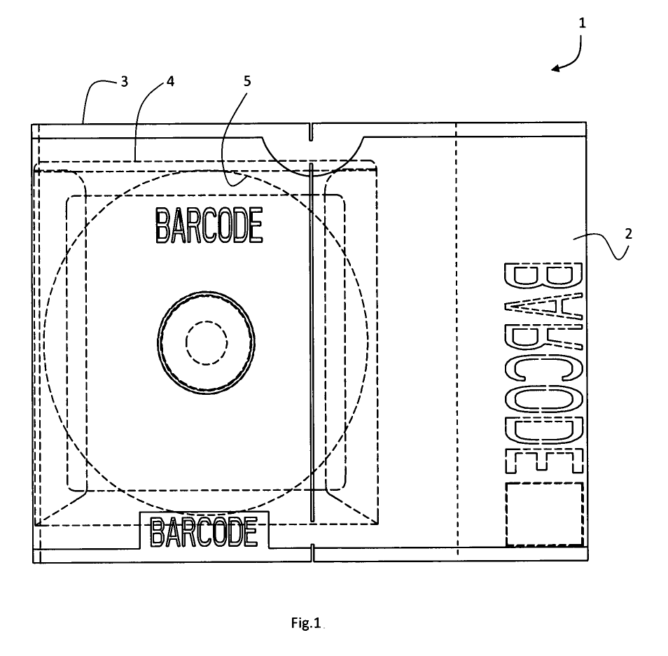

Referring to FIG. 1 a typical envelope which is processed by a system of the invention is illustrated. The envelope does not form part of the invention, but is shown for understanding of operation of the system and method of the invention. The envelope 1 comprises a sealed band 2 and an enclosure part 3 which encloses a media disc, in this case a DVD 5, in a sleeve 4.

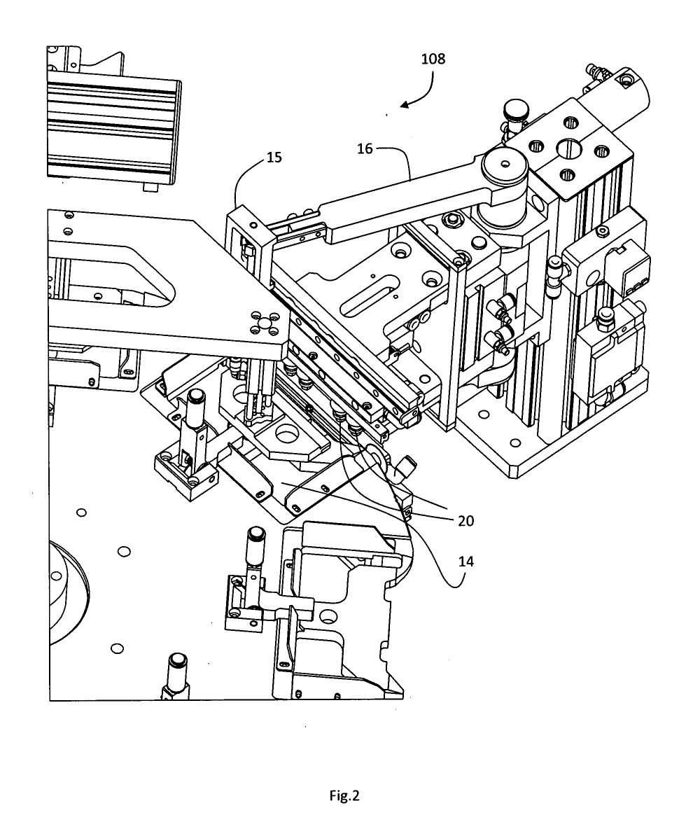

An envelope processing system comprises a cutting station 108, shown in FIG. 2. The station is one of eight stations in a carousel indexing table. The envelope 1 is routed onto a bed 14of the station 108, and top and bottom leaves of the envelope are cut by opposed cutting wheels on a carriage 15 carried on an arm 16 rotating in the horizontal plane and driven by a pneumatic cylinder. Suction cups 20 and 21 grip the top and bottom leaves of the envelope to separate them while the leaves are separately cut by the top and bottom cutters.

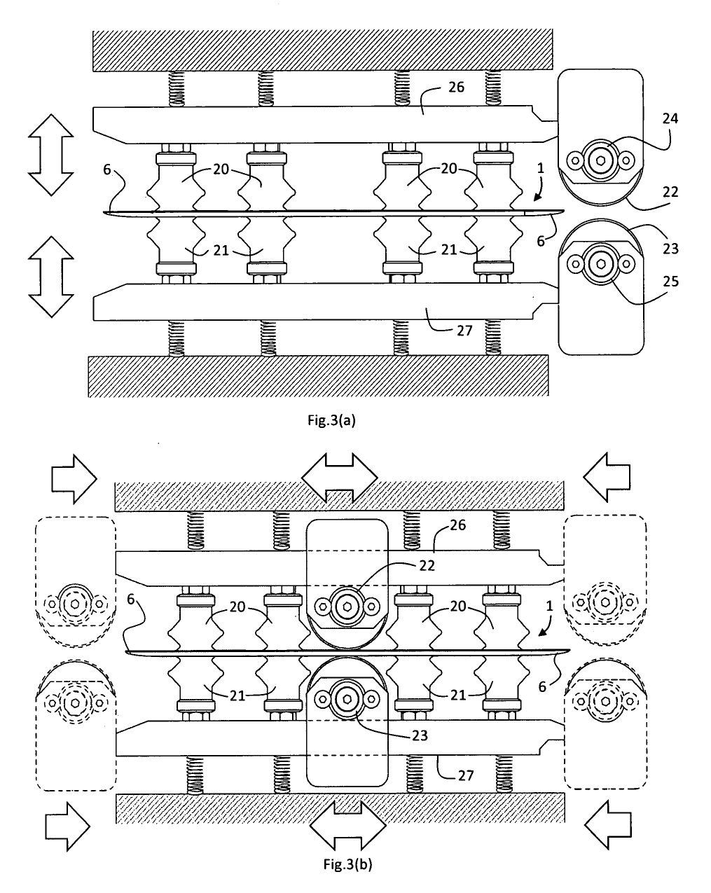

As shown in FIGS. 3(a) and 3(b) a line of top suction pads 20 and a line of bottom suction pads 21 are brought into contact with the top and bottom leaves of the envelope simultaneously. The movement of the suction pads 20 and 21 is driven by a pneumatic gripper. Once bellows suction cups make vacuum on the part they collapse into themselves and the top and bottom leaves separate from the sleeve 4 inside the envelope 1.

A separate pneumatic cylinder then causes cutting wheels 22 and 23 to traverse across the envelope and cut the top and bottom leaves respectively. The cut is almost completely across the envelope 1, leaving only a short un-cut portion 6 at each side edge, as the edges 6 remain between the cutting planes of the wheels 22 and 23. The cutting action is simple. Taking the top wheel 22 firstly, the wheel is supported on a shaft around which there is a gear, in this embodiment a rubber sleeve 24. A rail 26 is supported on the frame of the station 108 so that it extends across the bed. The rail is supported by springs so that if it is pushed up the springs provide a down ward bias force. When the drive mechanism for the wheel 22 pushes the wheel assembly across as shown in FIG. 3(b), the rubber sleeve 24 engages the rail 26 in a rack-and-pinion type of arrangement. Friction between the sleeve 24 and the rail 26 causes the sleeve, and hence the wheel 22, to rotate. Thus, the simple translational action of the drive mechanism causes the wheel 22 to both traverse the bed and also to rotate to cut the top leaf of the envelope 1 as the envelope leaf is held above the plane of the contents sleeve 4 by the suction cups 20.

The bottom wheel 23 has a sleeve 25 which engages a lower rail 27 in the same manner so that the lower leaf of the envelope is simultaneously cut. During this cutting action the contents of the sleeve 4 are retained in place by a pneumatic cylinder which clamps the disc and contents to a dial and ensures that the traversing blades do not come into contact with the contents as they cut the separate leafs of the envelope.

It will be appreciated that the cutting action is very simple because a single parallel gripper drives the vertical motion of the vacuum cups 20 and 21 and a second linear pneumatic cylinder creates the traversing movement for the cutting blades 22 and 23. Avoidance of need for motors for the cutting wheels is a major advantage in terms of physical bulk of the equipment which is required to move in the station 108 and also for reliability and maintenance.

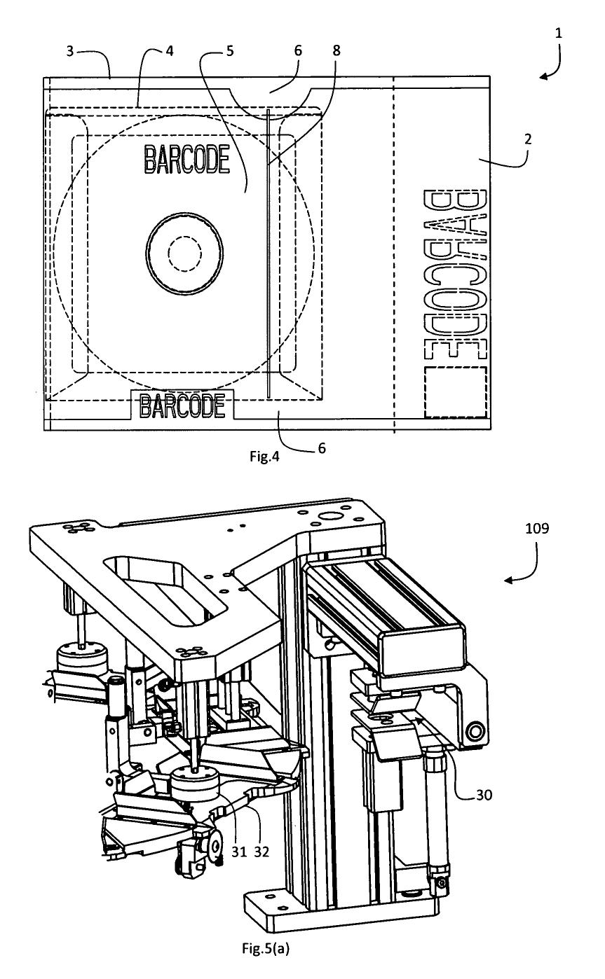

FIG. 4 shows the envelope after cutting by the station 108. There is a cut 8 across almost all of the width of the envelope, however, the transverse sides of the envelope 1 are still joined at the side edges as shown by the numerals 6.

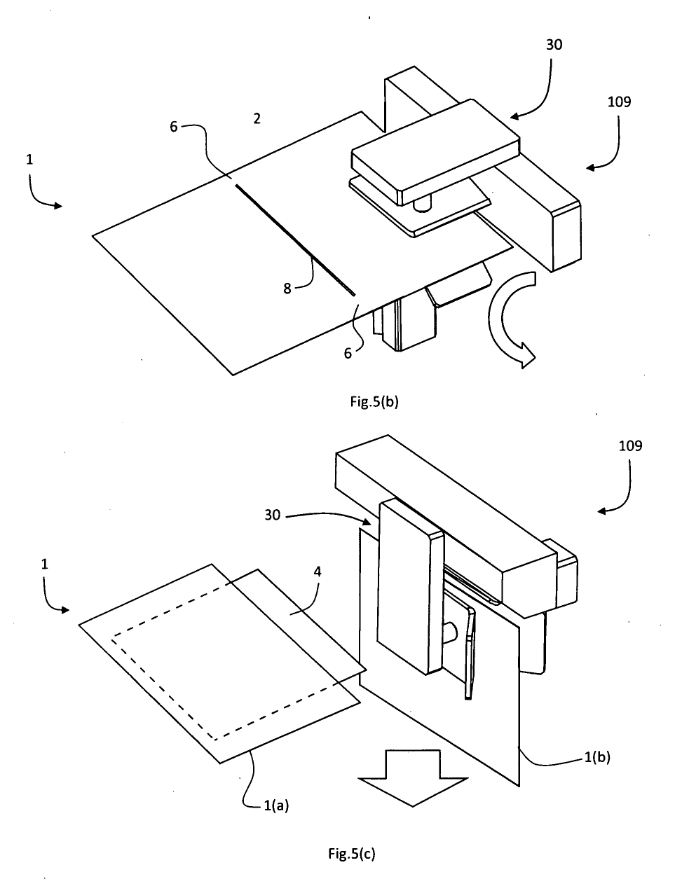

Referring to FIG. 5(a) a station 109 for separating the parts is shown. It is referred to as a tearing station as it tears the short (few millimetres) edges 6 of the envelope which are intact at the ends of the cut lines 8. The station 109 operates by an outer clamp 30 gripping the outer end of the envelope 2 while the inner end is clamped in position on the bed by an inner clamp comprising a piston 31 over the bed 32.

As shown in FIGS. 5(b) and 5(c) the outer clamp 30 has jaws which are pneumatically operated to close in the vertical direction to grip the envelope outer end and then it is rotated downwardly through 90° so that the edges 6 at the ends of the cut line are torn to separate the envelope 1 into two parts 1(a) and 1(b). Once these parts are separated the sleeve 4 is exposed, as shown in FIG. 5(c).

It will be appreciated that the separation of the two parts of the envelope is a simple operation, only requiring operation of two pneumatic clamps, and rotation of one of them. This latter action also allows the torn-away part 2 to be efficiently and conveniently discarded by being dropped by the outer clamp 30 onto a scrap chute for removing this part, 1(b), of the envelope.

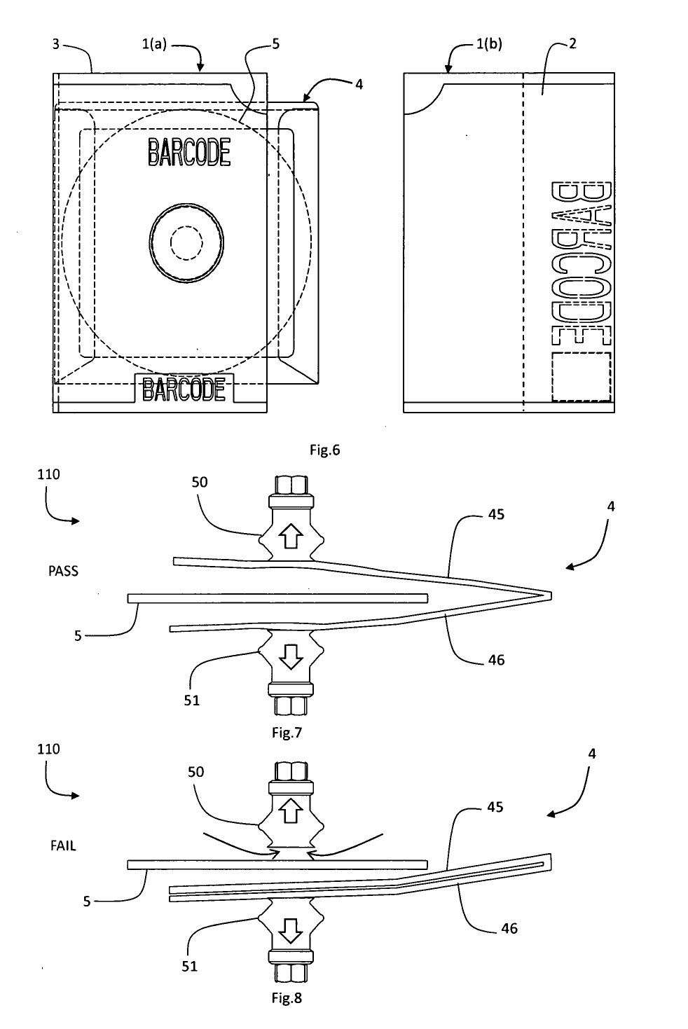

The separated envelope is shown in FIG. 6, which shows how some of the DVD sleeve 4 protrudes from the part 1(a).

The disc sleeve 5 is then processed by a sleeve-checking station to ensure that the DVD 5 is indeed in the sleeve 4. A number of subscribers may not place the DVD 5 in the sleeve 4, merely placing them alongside each other in the envelope, or maybe omitting the sleeve.

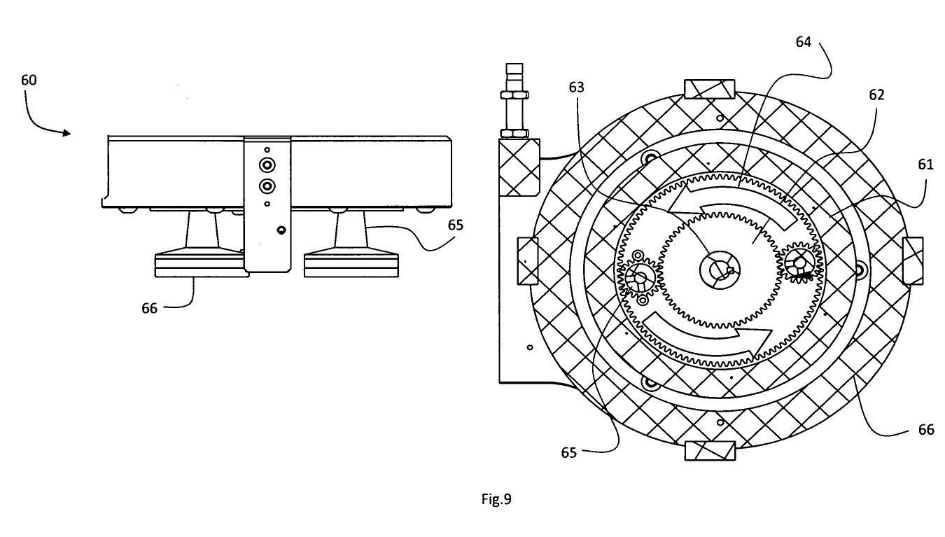

Referring to FIGS. 7 and 8 operation of the sleeve-checking station is illustrated. The envelope 3, sleeve 4, and disc 5 are clamped to restrict general movement in the vertical axis. Vacuum cups 50 and 51 are brought into contact with the exposed contents of the envelope 3 and a vacuum is applied. The cups 50 and 51 are then moved away from the plane of the contents of the envelope by a small distance and a sensor checks the status of the vacuum. Vacuum will be maintained if the disc 5 is inside the sleeve 4 as the material 45, 46 of the sleeve 4 will travel with the cups 50 and 51. This is determined as a pass. Vacuum will not be maintained if the disc 5 is either above or below the sleeve 4 as the disc can not travel with the cups 50 and 51 due to it being clamped in the vertical axis. The cups 50 and 51 will snap off the disc, vacuum will be lost and the orientation of the contents of the envelope determined as a fail.

Hence the sleeve-checking station 110 can immediately identify a fail without need for complex equipment such as machine vision equipment; mere failure of a suction pad to grip generating a fail alert.

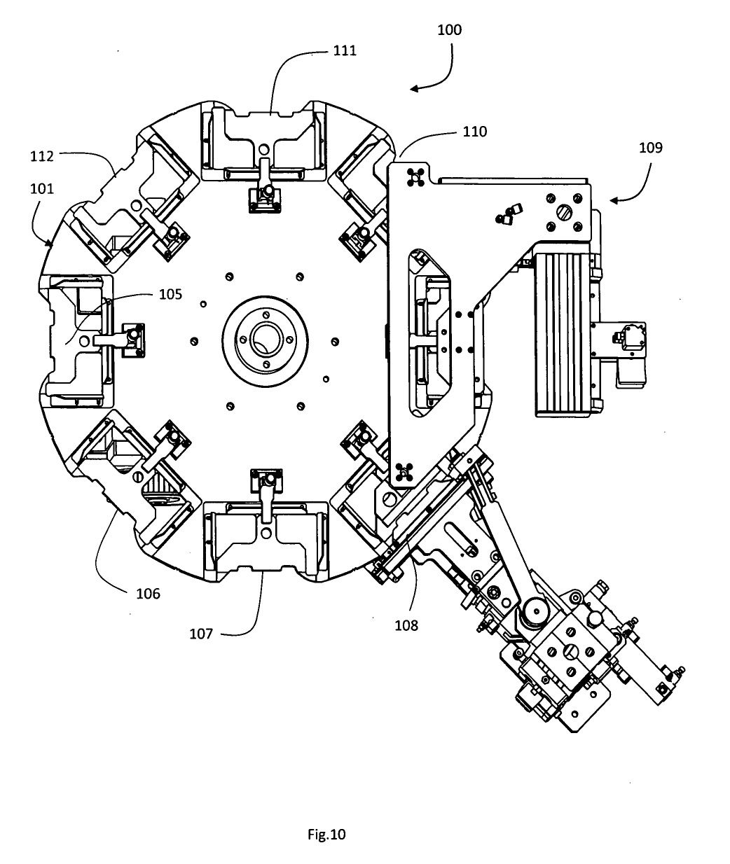

Referring to FIG. 9 a cleaning station 60 comprises foam cleaning heads 66 mounted on supports 65. A fixed inner gear 62 and an annular outer gear 61 define an annular path 64 between them. The gears 61 and 62 have teeth facing into the path 64, which teeth engage teeth on the supports 65. Rotation of the annular gear 61 causes the foam heads 66 to rotate at a high speed to cover the full surface of the DVD. It has been found in tests that a cleaning operation takes only about half a second using this station.

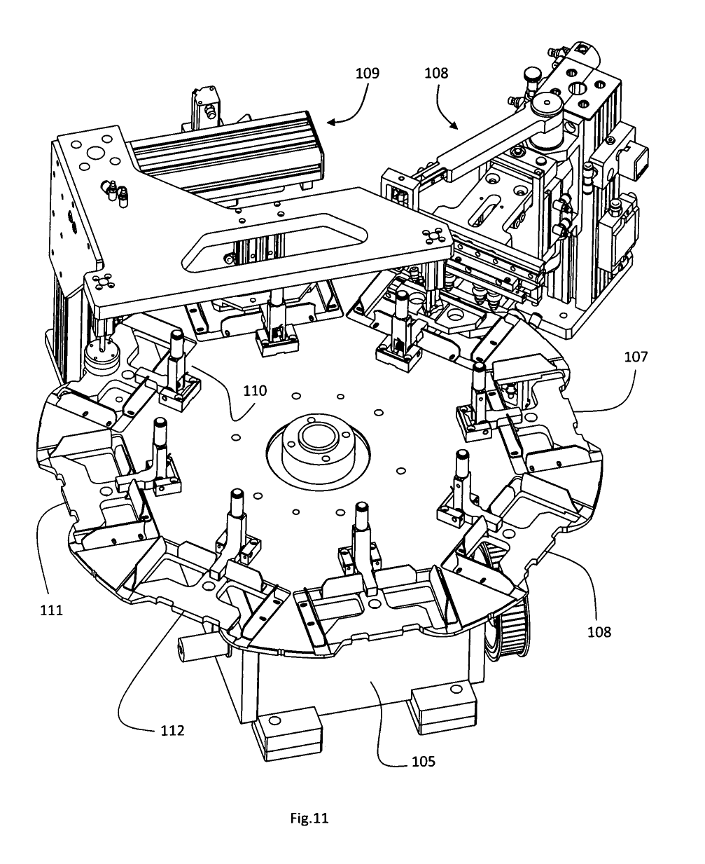

Referring to FIGS. 10 and 11 a first part 100 of the envelope processing station is illustrated. It comprises an in-feed station 105 which takes each envelope 1 from a linear conveyor in turn onto a bed of the carousel table. Rotation of the table through eight indexing steps brings the envelope through the various stations of:

106, thickness check station using a linear transducer to measure the contents of the envelope,

107, reject station in which rejects from the previous station are removed,

108, cutting station as described above,

109, tearing station to separate the two envelope parts as described above,

110, sleeve-checking station, as described above,

111, removal station for removal of the sleeve containing the DVD, and

112, removal station for removing the envelope.

The station 111 leads to a carousel indexing table which forms the second part of the overall system. This table indexes through stages for orienting the sleeve in the correct direction in relation to the table, using machine vision inspection heads. They also ensure that the DVD is correctly orientated, facing up, in the sleeve. One of these stations includes the cleaning station 60, shown in FIG. 9.

It will be appreciated that the use of carousel indexing tables to move the envelope and the contents through successive stations is very effective. Because the envelope remains in the bed of the table the extent of handling is minimised and there is improved registry for the successive stations. Also, the cutting operation is very effective as it avoids reliance on uniformity of the dimensions of the envelope and provides a cut which allows the envelope contents to protrude from a part of the envelope for further processing. Also, this operation ensures that the contents are not damaged. The tearing operation is a very simple way of completing the separation of the envelope parts. The checking station achieves a very effective check on insertion of the disc into the sleeve in a very simple manner, without need for machine vision equipment.

The embodiments described above have been set forth herein for the purpose of illustration. This description, however, should not be deemed to be a limitation on the scope of the invention. Various modifications, adaptations, and alternatives may occur to one skilled in the art without departing from the claimed inventive concept. The spirit and scope of the invention are indicated by the following claims. For example, instead of the translational strokes of the cutters and the suction pads being driven by pneumatic cylinders, they could alternatively be driven mechanically by a cam drive. Such a cam drive could have a cam for each, so that the separating and cutting operations are maintained in synchronism. Also, the disc cleaning and/or the contents checking stations could be provided separately, not necessarily following an opening station as described. Also, it is envisaged that rather than tearing the un-cut parts of the envelope beyond the cut line, these parts could be cut by the same or different cutters in a separate cutting operation.

1. A system for processing an envelope containing contents, the system comprising:
opposed cutters adapted to cut through envelope leaves,
a drive mechanism for the cutters,
wherein the system comprises a separator for drawing envelope leaves away from each other, and
wherein the drive mechanism is adapted to drive the cutters to separately cut the opposed leaves of the envelope while they are drawn away from each other by the separator.

2. The system as claimed in claim 1, wherein the cutters include at least one wheel for cutting through an envelope leaf, and the drive mechanism is adapted to rotate the wheel and to cause it to traverse across the envelope.

3. The system as claimed in claim 1, wherein the cutters include at least one wheel for cutting through an envelope leaf, and the drive mechanism is adapted to rotate the wheel and to cause it to traverse across the envelope; and wherein the drive mechanism is adapted to simultaneously drive the wheels to cut both envelope leaves simultaneously.

4. The system as claimed in claim 1, wherein the separator comprises opposed suction cups adapted to engage envelope leaves and to draw them away from a plane of the envelope contents.

5. The system as claimed in claim 1, wherein the drive mechanism comprises a rail and a gear on the wheel engaging the rail in a rack-and-pinion type of action as the wheel traverses an envelope, translational motion of a wheel assembly along the rail causing rotation of the wheel.

6. The system as claimed in claim 1, wherein the drive mechanism comprises a rail and a gear on the wheel engaging the rail in a rack-and-pinion type of action as the wheel traverses an envelope, translational motion of a wheel assembly along the rail causing rotation of the wheel; and wherein the gear comprises a high-friction rubber or plastics material for engaging the rail by friction.

7. The system as claimed in claim 1, wherein the drive mechanism comprises a rail and a gear on the wheel engaging the rail in a rack-and-pinion type of action as the wheel traverses an envelope, translational motion of a wheel assembly along the rail causing rotation of the wheel; and wherein the rail is biased towards the gear.

8. The system as claimed in claim 1, wherein the separator and the cutters are driven by a single drive shaft having a cam for driving the cutters and a cam for driving the separator.

9. The system as claimed in claim 1, wherein the separator and the cutters are driven by pneumatic rams.

10. The system as claimed in claim 1, further comprising a tearing station for completing separation of parts of the envelope by tearing remaining envelope material which joins them after cutting.

11. The system as claimed in claim 1, further comprising a tearing station for completing separation of parts of the envelope by tearing remaining envelope material which joins them after cutting; and wherein the tearing station comprises a clamp for gripping each envelope part and a drive for mutual separation of the clamps to tear said material.

12. The system as claimed in claim 1, further comprising a tearing station for completing separation of parts of the envelope by tearing remaining envelope material which joins them after cutting; and wherein the tearing station comprises a clamp for gripping each envelope part and a drive for mutual separation of the clamps to tear said material; and
wherein the clamp drive is adapted to rotate a clamp away from the plane of the envelope, and the clamp is adapted to release the envelope part held by the rotated clamp.

13. The system as claimed in claim 1, further comprising an inspection station for inspecting the contents by checking for insertion of an item in a sleeve contained in the envelope.

14. The system as claimed in claim 1, further comprising an inspection station for inspecting the contents by checking for insertion of an item in a sleeve contained in the envelope;
and wherein the inspection station comprises a suction cup arranged to attempt to grip the sleeve, failure of gripping indicating that the cup is in contact with the item instead of the sleeve, and said inspection station is adapted to grip the item to prevent movement of the item with movement of a cup, hence breaking suction if the cup is engaged with the item instead of the sleeve.

15. The system as claimed in claim 1, further comprising a media disc cleaning station comprising at least one cleaning head and a planetary gear drive for the head.

16. The system as claimed in claim 1, further comprising a media disc cleaning station comprising at least one cleaning head and a planetary gear drive for the head; and
wherein the planetary gear drive comprises an inner gear and an outer annular gear defining a path between them, the path having teeth engaging g a cleaning head drive shaft, whereby mutual rotation of at least the outer and inner gear causes rotation of the cleaning head in a circular orbit and to rotate about its own axis.

17. The system as claimed in claim 1, wherein the system comprises stations located around at least one carousel indexing table having a plurality of beds, an envelope intake for placing an envelope on an empty bed upon each indexing rotation of the table, a controller adapted to synchronise timing of operation of the stations, and wherein at least one of said stations includes said separator, said cutters, and said cutter drive mechanism.

18. The system as claimed in claim 1, wherein the system comprises stations located around at least one carousel indexing table having a plurality of beds, an envelope intake for placing an envelope on an empty bed upon each indexing rotation of the table, a controller adapted to synchronise timing of operation of the stations, and wherein at least one of said stations includes said separator, said cutters, and said cutter drive mechanism;
and wherein the system comprises a first carousel for processing envelopes and a second carousel for processing contents removed from the envelopes.

19. The system as claimed in claim 1, wherein the system comprises stations located around at least one carousel indexing table having a plurality of beds, an envelope intake for placing an envelope on an empty bed upon each indexing rotation of the table, a controller adapted to synchronise timing of operation of the stations, and wherein at least one of said stations includes said separator, said cutters, and said cutter drive mechanism; and wherein the system comprises a first carousel for processing envelopes and a second carousel for processing contents removed from the envelopes; and wherein the second carousel includes a media cleaning station.

20. The system as claimed in claim 1, wherein the system comprises stations located around at least one carousel indexing table having a plurality of beds, an envelope intake for placing an envelope on an empty bed upon each indexing rotation of the table, a controller adapted to synchronise timing of operation of the stations, and wherein at least one of said stations includes said separator, said cutters, and said cutter drive mechanism; and wherein the system comprises a first carousel for processing envelopes and a second carousel for processing contents removed from the envelopes; and wherein the second carousel comprises stations for correcting orientation of contents and mutual orientation of parts of contents such as a media disc in a sleeve.

21. A method of processing an envelope containing contents, the method being implemented by a system comprising opposed cutters adapted to cut through envelope leaves, a drive mechanism for the cutters, a separator, and a drive mechanism, the method comprising the steps of:
the separator applying suction to opposed leaves of the envelope to cause them to separate, and
the cutters separately cutting through the opposed leaves while they are separated and the contents are between the cutters.

22. The method as claimed in claim 21, wherein the cutters are wheels which are simultaneously rotated and driven across the envelope in a translational motion to cut the leaves, and the method comprises the further step of tearing uncut parts of the envelope beyond the ends of a cut line by gripping opposed ends of the envelope and pulling them apart.

23. A media disc cleaning system comprising at least one cleaning head and a planetary gear drive for the head, wherein the planetary gear drive comprises an inner gear and an outer annular gear defining a path between them, the path having teeth engaging g a cleaning head drive shaft, whereby mutual rotation of at least the outer and inner gear causes rotation of the cleaning head in a circular orbit and to rotate about its own axis.
